(19) United States
(12) Patent Application Publication
(10) Pub. No.: US 2026/0337055 A1
(43) Pub. Date: Oct. 29, 2026

(54) Method for Treating Dirty Overflow Water from a Water Treatment Plant, and Corresponding Facility

(71) Applicant: Veolia Water Solutions & Technologies Support, Saint-Maurice (FR)

(72) Inventors: Philippe Sauvignet, Maen Roch (FR); Nicolas Pays, Pontaubault (FR)

(21) Appl. No.: 19/103,871

(22) PCT Filed: Aug. 17, 2023
(86) PCT No.: PCT/EP2023/072735

§ 371 Date: Feb. 14, 2025

(30) Foreign Application Priority Data
Aug. 17, 2022 (FR) FR2208342

(51) Int. Cl. C02F 1/20; C02F 1/38

(52) U.S. Cl. CPC C02F 1/20; C02F 1/385; C02F 2209/03; C02F 2209/40; C02F 2301/046; C02F 2301/08

(57) ABSTRACT

The invention relates to a method for treating dirty overflow water in order to separate suspended matter and insoluble granular material that is heavier than water. This method involves a degassing step (1), two solid-liquid separation steps inside a hydrocyclone (4) and a recirculation cylinder (5), and a step of recirculating the water to be treated, implemented by a hydroejector (3).

### TECHNICAL FIELD

The field of the invention is that of water treatment for its purification or its potabilization. More precisely, the invention relates to the treatment of dirty water that is coagulated and possibly flocculated beforehand, coming from a water treatment plant.

### PRIOR ART

A well-known method for treating water, in particular surface water to be made fit for drinking and urban or industrial wastewater to be depolluted, consists of coagulating the water to be treated with a coagulating reagent, such as a trivalent metal salt, flocculating the organic matter contained in the coagulated water with a flocculating reagent, usually consisting of an organic polymer, and settling or filtering the flocs and other solid matter in a settling tank or through a filter. In the case of the settling tank, sludge is extracted from the bottom of the settling tank, and treated water is extracted at the settling tank overflow; while in the case of a filter, the filtered water is extracted from one side of the filter, and the sludge and/or dirty water are extracted by backwashing through the filter overflow.

More particularly, a technological example implementing coagulation and flocculation steps consists of adding coagulants and/or flocculants to the untreated water, in order to obtain flocs. The water thus coagulated and/or flocculated can be filtered through an ultrafiltration membrane, the flocs forming a cake at the surface of the membrane, and the clarified water passing through it. The cake of flocs can then be removed by backwashing of the membrane and overflowing a tarp of dirty wash water.

In this way, dirty water is recovered as an overflow of the filtration facility, by filter or membranes, this dirty water being able to then be thickened and/or dehydrated in post-treatment systems. However, such a method leads to high water losses and a costly and high-footprint post-treatment.

Another technological example implementing steps of coagulation and flocculation is proposed by the Actiflo® method, which uses a ballast consisting of a fine, high-density granular material, such as microsand for example, injected into or upstream of the flocculation zone, in order to increase the speed of formation of flocs by acting as a flocculation initiator, and also, through increasing their density, increasing the speed of settling of the flocs formed during the flocculation phase. The ballasted sludge is extracted from the bottom of the settling tank.

Microsand, of average diameter between approximately 20 and 300 micrometres, usually between 80 and 200 micrometres, is the most frequently used ballast, for reasons of availability and cost.

For economic reasons relating to reuse, the ballast is usually separated from the sludge extracted from the settling plant and recycled into the process.

The ballast losses are usually distributed between losses via the treated water leaving as overflow of the settling tank and losses with the sludge extracted from the plants.

An injection of fresh ballast is provided in order to compensate the ballast losses. It is important to control losses of ballast entrained with the sludge, both to minimise the expenditure on fresh ballast and to avoid degrading the quality of the sludge extracted. The means used to separate the ballast from the extracted sludge and to recycle this ballast into the process by minimising ballast losses are, in general, chosen from static, gravity-driven separation techniques (such as settling) or dynamic techniques (such as centrifugation and cycloning), most often by hydrocycloning the sludge/ballast mixture. The ballast losses in the overflow of the hydrocyclone, the means most often used in practice in order to separate the ballast from the extracted sludge are, in general, and for a hydrocyclone geometry and fixed operating conditions, approximately proportional to the concentration of the ballast in the mixture entering into the hydrocyclone.

In order to reduce these ballast losses, it has already been proposed in the prior art to treat this overflow in a second hydrocyclone. Such a use of two hydrocyclones mounted in cascade is disclosed, in particular, in WO03053862A1.

However, this method leads to volumes of sludge at the outlet of the second hydrocyclone, containing an even larger proportion of water. Thus, these diluted sludges are responsible for water losses.

These sludges therefore need to be thickened and dehydrated during a post-treatment. Such a post-treatment increases the costs of implementing the method. Moreover, the corresponding equipment increases the footprint of the facilities.

Also known for limiting water losses is the invention disclosed in WO2011103651A1 known by the name Actiflo® HCS. It relates to a facility for ballasted flocculation-settling, including a simplified system for recirculating part of the overflow from the hydrocyclone for separation of the ballasted sludge. A part of the overflow of the hydrocyclone is returned, after degassing, to the suction side of the sludge/ballast mixture extraction pump feeding the hydrocyclone. This regulated recirculation system makes it possible to reduce the volume of water extracted with the sludges, and therefore to concentrate the sludges. It also enables ballast losses to be reduced. However, it cannot be used on all types of water and must be selected as a function of the load and the flow rate of the water to be treated.

### OBJECTIVES OF THE INVENTION

The objective of the invention is to provide a method that can overcome these disadvantages of the prior art.

More precisely, the main objective of the invention is to provide a method for treating dirty overflow water coming from a water treatment plant, making it possible to limit the water losses.

Another objective of the invention is to reduce the volume of sludges produced by such a water treatment plant.

Another objective of the invention is to provide a method which makes it possible to reduce the quantities of chemical products that need to be used in such a plant and therefore to limit the ecological impact of the corresponding treatment.

Another objective of the invention is to provide a device for implementing such a method enabling the footprint of such a plant to be limited.

### DESCRIPTION OF THE INVENTION

These objectives, as well as others which will appear in the following, are achieved using a method for treating dirty overflow water used in order to separate, on the one hand, treated water and, on the other hand, solid particles contained in the dirty overflow water, said solid particles being composed of suspended matter and/or insoluble granular material that is heavier than water. This method comprises the following steps:
a degassing step of the dirty overflow water;
a step of feeding degassed dirty overflow water to a hydrocyclone via a hydroejector fed by an accelerating pump, said accelerating pump being capable of adjusting a flow rate and a pressure;
a first separation step of suspended matter and/or granular material present in the degassed dirty overflow water, by hydrocycloning inside the hydrocyclone;
a step of recovering an overflow of the hydrocyclone, the overflow mainly comprising water and residual suspended matter;
a second separation step of the residual suspended matter from the recovered overflow water of said hydrocyclone, inside a recirculation cylinder;
a step of recirculating, to the hydrocyclone, water comprising said residual suspended matter coming from the recirculation cylinder through suction by the hydroejector;
a step of extracting clarified water at the outlet of the recirculation cylinder;
a step of continuously measuring the flow rate at the inlet and at outlet of said hydroejector, and at the outlet of said recirculation cylinder.

According to the invention, in order to be able to remove the suspended matter present at the overflow outlet of a facility upstream, the invention proposes implementing a method for treating this dirty overflow water, comprising two solid-liquid separation steps using a hydrocyclone and a recirculation cylinder, coupled with recirculation of the water at the outlet of the recirculation cylinder.

According to the present description, the term “recirculation cylinder” designates a cylinder comprising the following elements: a water feed close to one of the ends of the cylinder (connected to the overflow of the hydrocyclone), a clarified water outlet positioned at the other end of the cylinder, a discharge for solid particles positioned at the periphery of the cylinder between the feed and the outlet of the cylinder and connected to the hydroejector, and a centrifugation system.

The function of this recirculation cylinder is similar to that of a hydrocyclone in that the recirculation cylinder produces a vortex creating a centrifugation of the water contained in the cylinder, enabling a liquid-solid separation. The centrifugal force created by the turbulent flow in which the fluid rotates around an axis causes the ejection of solid particles at the periphery of the cylinder wall. The water discharged by a tangential outlet becomes loaded with solid particles. The clarified water is discharged at the centre of the cylinder.

According to the present invention, the dirty overflow water, thus undergoes at least a first solid-liquid separation step (or hydrocycloning) in the hydrocyclone; then the overflow water of the hydrocyclone likewise undergoes at least a second solid-liquid separation step in the recirculation cylinder, which has a lower cut-off threshold than the hydrocyclone, and making it possible to separate the majority of the residual particles in suspension which have not been separated from the water during the first solid-liquid separation step.

In order to limit the water losses, the water containing the residual particles in suspension recovered on the cylinder wall and separated from the clarified water during the second solid-liquid separation step is reintroduced during the feed step of the hydrocyclone via the recirculation loop. Thus, the water coming from the recirculation cylinder and containing suspended matter is sucked by a hydroejector (device using the Venturi effect to create suction), and is recirculated to the hydrocyclone in order to optimise its treatment and to remove the residual suspended matter. Thus, this method makes it possible to optimise liquid-solid separation, in particular for extremely fine solid particles (suspended matter), while limiting water losses.

Moreover, the establishing of a continuous measurement of the flow rate and pressure also enables the correct operation of the method to be controlled.

Furthermore, in order to avoid any malfunction linked to the presence of air, the method describes putting in place a degassing step upstream of the feed step.

According to a preferred feature of the invention, the method comprises a step of continuously measuring the flow rate of the accelerating pump and a step of adjusting this continuous flow rate as a function of the result of the measurement taken during the measurement step; the step of adjusting the flow rate of said accelerating pump being such that, for a flow rate at the inlet of said hydroejector of x m³/h, then the flow rate at the hydroejector outlet is between 1.1× and 1.5× m³/h, the flow rate at the underflow outlet of the hydrocyclone is less than 0.1× m³/h, the recirculation flow rate is between 0.1× and 0.5× m³/h, and the flow rate at the overflow outlet of the recirculation cylinder is between 0.9× and 0.95× m³/h.

In order to establish the recirculation loop making it possible to suck the water containing residual suspended matter coming from the recirculation cylinder, the invention proposes maintaining a specific flow rate at each step of the method. Thus, advantageously, the optimisation of the method according to the invention is enabled by the use of a variable speed accelerating pump and the establishing of a continuous measurement of the flow rate. More specifically, the method according to the invention has a very specific operating point, requiring continuous maintenance of adequate conditions. In particular, the set of parameters used in this method are co-dependent (flow rate, pressure, features of the hydroejector and the hydrocyclones, etc.). Thus, in order to limit the water losses and maximise the removal of suspended matter, the method according to the invention proposes regulating the flow rate during each step of the method in order to obtain, at the outlet of the recirculation cylinder, a flow rate close to the flow rate at the hydroejector inlet, in other words approximately equal to x m³/h, and more precisely, a flow rate between 0.9× and 0.95× m³/h.

According to another feature of the invention, the method comprises a step of adding polymer to the degassed dirty overflow water upstream of said hydroejector and/or at the inlet of the recirculation cylinder.

Advantageously, the addition of polymer to the water to be treated enables the removal of the suspended matter to be improved. More specifically, the addition of polymers in the dirty overflow water to be treated, before their arrival in the hydroejector, makes it possible to agglomerate all of the particles of suspended matter, and thus to increase the size of these particles, which facilitates their separation from the water during the various solid-liquid separation steps.

This step of adding polymers can be carried out automatically as a function of a suspended matter content, at the inlet of the hydroejector and/or at the inlet of the recirculation cylinder.

According to an advantageous feature of the invention, the flow rate at the hydroejector inlet x is between 4 and 50 m³/h.

Thus, the method according to the invention advantageously makes it possible to control the flow rate and to adapt it for optimisation of the steps of solid-liquid separation and recirculation of the water to be treated. Moreover, the respect of a predetermined flow rate at the pump outlet makes it possible to maintain the conditions corresponding to the specific operating point (flow rates, pressure) of the method, and thus to optimise the 5 efficiency thereof by limiting water losses and by maximising the removal of suspended matter.

Preferably, the hydraulic residence time is between 2 s and 4 s inside the hydrocyclone and inside the recirculation cylinder.

Thus, respecting a specific hydraulic residence time makes it possible to optimise the separation of the suspended matter from the water, during the solid-liquid separation steps. According to a preferred variant, the hydrocyclone has a cut-off threshold between 10 and μm, and the recirculation cylinder has a cut-off threshold between 5 and 15 μm.

Thus, this method makes it possible to remove extremely fine particles (for example flocs), the density of which is relatively close to that of water. These cut-off thresholds make it possible to limit the use of chemical products due to their effectiveness on fine particles. More specifically, these two mechanical liquid-solid separation steps do not require the use of coagulant or flocculant products in order to effectively separate the extremely fine contaminants from water.

According to an advantageous feature, the pressure of the water at the outlet of said accelerating pump is between 2 and 5 bar.

This pressure is adapted for the treatment of the water, and is one of the specific parameters of the method making it possible to respect the specific operating point thereof. More specifically, a pressure of 2 to 4 bar at the accelerating pump outlet, makes it possible, after passage of the water in the hydroejector, to obtain a pressure between 1.5 and 2.5 bar at the inlet of the hydrocyclone, due to the pressure losses induced by the Venturi effect (approximately 1 to 1.5 bar). Thus, the pressure obtained at the hydrocyclone and recirculation cylinder inlets enables use of cut-off thresholds enabling an optimum separation of the suspended matter.

According to another preferred aspect of the invention, the hydroejector comprises a nozzle, for which the outlet diameter is between one fifth and half of its inlet diameter.

In order to create a Venturi effect generating a sufficient suction force to enable the recirculation of a part of the water coming from the recirculation cylinder to the hydrocyclone, the method proposes adjusting the diameter of the nozzle in order to respect the specific operating point of the method. In particular, the pressure losses and suction 35 force depend on the inlet and outlet diameters of the hydroejector nozzle. More specifically, the smaller the outlet diameter relative to the inlet diameter, the larger will be the pressure losses and the suction force, while for an outlet diameter relatively close to the inlet diameter, the pressure losses and the suction force are lower. According to a preferred variant of the invention, the dirty overflow water comes from a hydrocyclone of a ballasted flocculation-settling facility.

According to other variants, the dirty overflow water could also come from a filtration system, said filtration system belonging to the group comprising:
sand filters;
granulated activated carbon filters;
ultrafiltration membranes;
biological filters using a biomass fixed on a granular support, such as the filter marketed under the registered trademark Biostyr;
mechanical filters, such as Hydrotech or others.

The invention also relates to a device for treating dirty overflow water in order to separate suspended matter and insoluble granular material that is heavier than water, for implementing a method such as that described above. The device comprises:
degassing means at the inlet of said facility;
an accelerating pump capable of adjusting a flow rate and a pressure;
a hydroejector;
a hydrocyclone fed by the water coming from the hydroejector;
a recirculation cylinder fed by the water coming from the overflow of the hydrocyclone;
means for measuring pressure and/or flow rate;
the hydroejector being capable of recirculating a part of the water coming from the recirculation cylinder to the hydrocyclone.

According to a feature of the invention, the device comprises means for adding polymer, provided upstream of the hydroejector and/or at the inlet of the recirculation cylinder.

According to a preferred feature of the invention, the recirculation cylinder is positioned horizontally.

More specifically, the device can be installed at the top of a ballasted flocculation-settling device from the prior art, and be connected to the overflow of its hydrocyclone, such a configuration enabling the footprint of the assembly to be minimised.

According to a preferred feature of the invention, the hydrocyclone and the recirculation cylinder each have a length between 0.8 and 2 m.

Thus, the device is relatively compact and with a small footprint, and can be placed in the upper part of a pre-existing facility of the prior art.

### DESCRIPTION OF THE FIGURES

Other features and advantages of the invention will become clearer on reading the following description of a preferred embodiment, which is given by way of a simple illustrative and non-limiting example, and described with reference to the drawings, in which:

FIG. 1 represents a device for treating a dirty overflow water, according to an embodiment of the invention;

FIG. 2 represents a ballasted flocculation-settling facility equipped with such a device.

### DETAILED DESCRIPTION OF THE INVENTION

### 1. Description of an Embodiment of a Device According to the Invention

The device according to the invention is fed with dirty water coming from a water treatment plant. This water treatment plant can, for example, be in the form of a ballasted flocculation-settling facility, a biofilter, an ultrafiltration membrane, a sand filter, or any other water treatment facility. Within the water treatment plant, the water has previously undergone physico-chemical treatments. The dirty water can thus have been coagulated and potentially flocculated and/or ballasted, before being filtered and/or settled and/or hydrocycloned. The dirty water feeding the device according to the invention can therefore come from the pressurised overflow 100 of a hydrocyclone of a ballasted flocculation-settling facility, or even from the overflow 100 (pressurised, or gravity-driven) for backwashing a filter (biofilter, ultrafiltration, sand filter, activated carbon, etc.) or any type of separator used in a water treatment plant.

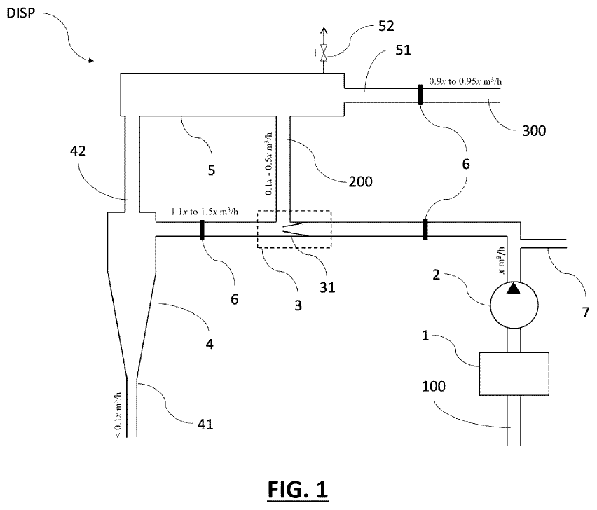

With reference to FIG. 1, the device DISP according to the invention comprises degassing means 1 for removing any air from the dirty water at the inlet of the device. This device also comprises an acceleration pump 2 acting as a driving force, which enables water from the degassing means to be brought to a Venturi effect hydroejector 3. The water is then sent to a hydrocyclone 4. At the underflow 41 of this hydrocyclone, granular material that can be used to ballast the flocs, as well as a large part of the suspended matter, are recovered in the form of sludge. The granular material acting as ballast can optionally be reused. At the overflow 42 of the hydrocyclone, pre-treated water containing only extremely fine residual suspended matter is recovered. The water may potentially also contain residual granular materials. This pretreated water is sent to a recirculation cylinder 5 inside which the residual particles are separated from the treated water by centrifugation through the creation of a vortex. The particles are therefore located on the walls of the recirculation cylinder, and then sucked in, through the Venturi effect, by the hydroejector 3 connected to the wall of the recirculation cylinder. The residual suspended matter coming from the recirculation cylinder is thus mixed with the untreated dirty water coming from the degassing vessel or column, inside the hydroejector, then the mixture is sent to the hydrocyclone 4, etc. This recirculation loop therefore makes it possible to re-treat this residual suspended matter until optimum removal of contaminants is achieved.

The flow rate inside the device implemented by the method according to the invention, changes as a function of the method step. Thus, at the accelerating pump outlet, the flow rate is preferably between 4 and 50 m³/h. Then, taking this feed flow rate as reference and assigning the value x, the feed flow rate of the hydrocyclone is advantageously between 1.1× and 1.5×, the underflow flow rate of the hydrocyclone is preferably less than 0.1×, the recirculation flow rate is advantageously between 0.1× and 0.5× and, finally, the outlet flow rate is preferably between 0.9× and 0.95×. It is noted that the flow rate does not depend on the size of the nozzle 31, unlike the circulation speed.

It is possible to place a plurality of treatment plants according to the invention in parallel, in order to treat a larger total flow rate.

### 2. Features of the Elements Constituting the Device According to an Exemplary Embodiment of the Invention

### 2.1. Sensors

Flow rate and pressure sensors 6 can be disposed between each treatment step. These sensors enable the direction of circulation of the water to be verified (in the event of malfunction), as well as the quantity of recirculated water. This enables the pressure at the inlet of the device to be adapted in order to maintain optimum treatment conditions.

### 2.2. Degassing Means

The degassing means 1 can remove air or any gas potentially contained in the dirty water to be treated. These means are for example a vessel, a tarp or a degasser. They thus make it possible to avoid the presence of any air which could give rise to phenomena provoking malfunctions inside the facility (for example, the phenomenon of cavitation of the pump). Hydraulic means, such as vents or bleeders, can also be used in order to ensure the absence of air and/or gas in the device. These means can be located at any treatment step of the device, in particular at the solid-liquid separation steps. This makes it possible, inter alia, to avoid cavitation phenomena (which could cause malfunctions, in particular at the feed pump and the Venturi effect hydroejector).

### 2.3. Accelerating Pump

The accelerating pump 2 acts as a driving force and can feed the device with degassed dirty overflow water.

The accelerating pump 2 enables the flow rate and pressure parameters to be very finely controlled. This pump preferably operates in relation with the sensors 6. This pump can be a variable frequency pump.

In the embodiment implemented by the inventor during its tests, the pressure delivered by the accelerating pump was 3 to 4.5 bar.

### 2.4. Venturi Effect Hydroejector

The hydroejector 3 is fed by the accelerating pump 2, and also feeds into the recirculation cylinder 5. More specifically, the pump provides the degassed water flow rate necessary for the hydroejector to suck, by the Venturi effect, part of the water contained in the recirculation cylinder (this water containing solid particles to be extracted from the water), the hydroejector being connected to the wall of the recirculation cylinder.

The hydroejector is composed of a nozzle 31, the conical shape of which (combined with the flow rate generated by the accelerating pump) enables the creation of the Venturi effect. At the nozzle outlet (inlet side of the hydrocyclone) the outlet diameter is between one fifth and one half of the inlet diameter of the nozzle (accelerating pump side). This ratio must be respected because in the case of an outlet diameter that is too small, the pressure loss will be too large, and for a diameter that is too large, the Venturi effect would disappear. The nozzle outlet diameters used by the inventor during its tests were between 2 and 15 mm. Moreover, the angle formed by the nozzle likewise influences the Venturi effect. The speed of circulation of the water inside the device is advantageously 0.5 to 2 m/s, except inside the Venturi effect hydroejector where the water is accelerated by 4 to 25 times, in order to obtain a speed of 2 to 50 m/s. The speed of circulation of the water inside the hydroejector 3 can be modulated and depends on the diameter of the nozzle 31. The speed of circulation at the outlet of the hydroejector 3 is therefore between 0.5 and 2 m/s. The passage of the water to be treated by the hydroejector induces a reduction in the pressure. The smaller the diameter of the nozzle, the larger the pressure loss. Similarly, the higher the flow rate, the larger the pressure loss. In the embodiment implemented by the inventor during its tests, the pressure losses due to the Venturi effect were 1 to 1.5 bar. The materials used for manufacture of the nozzle (and for all the elements of the device) need to be resistant to abrasion and be adapted to the viscosity of the water.

The Venturi effect has a precise operating point for enabling suction of the suspended matter coming from the recirculation cylinder. This suction depends on the pressure and flow rate delivered by the accelerating pump, as well as the inherent parameters of the hydroejector (diameter, nozzle angle).

### 2.5. Hydrocyclone

The hydrocyclone 4 can separate and remove the solid particles contained in the water to be treated coming from the hydroejector 3. The heaviest particles are then extracted via the underflow of the hydrocyclone 4, while the overflow containing the finest particles (residual particles) is transferred into the recirculation cylinder 5.

The solid particles removed from the underflow of the hydrocyclone may comprise granular materials serving as ballast. These granular materials can be recycled in order to be reused in the steps upstream of the device.

The hydrocyclone used in the device has a cut-off threshold between 5 and 25 μm. This threshold depends on the flow rate, the pressure and the hydraulic residence time.

The cut-off threshold of the hydrocyclone can be adapted for the separation of microsands particles and particles of equivalent density (10 to 25 μm), or for the separation of lower density particles (5 to 15 μm). Thus, this cut-off threshold, like the cut-off threshold of the recirculation cylinder, can be adapted according to the particles (density, size) contained in the water to be treated.

The hydrocyclone preferably measures between 0.8 and 2 m in length, with a hydraulic residence time between 1 and 4 s, and an internal speed of 0.5 to 1 m/s. The optimum performance for such a hydrocyclone is obtained for a hydraulic residence time of 4 seconds. More specifically, the longer the hydraulic residence time, the more effective is the liquid-solid separation. According to an exemplary embodiment, the hydrocyclone is similar to a hydrocyclone of a ballasted flocculation-settling facility, but is more fusiform. The hydrocyclone can optionally be of a size greater than 2 m, depending on the desired use. Thus, the hydraulic residence time can be increased and enables an improvement in the liquid-solid separation yield.

In an exemplary embodiment, the hydrocyclone is positioned vertically.

In the embodiment implemented by the inventor during its tests, the hydrocyclone functioned at a pressure of 1 to 1.5 bar. In particular, in the case of use of the device of the invention following a ballasted flocculation-settling facility comprising a first hydrocyclone, it is necessary to work at higher pressures than for the first hydrocyclone of the ballasted flocculation-settling facility.

### 2.6. Recirculation Cylinder

According to the present description, the term “recirculation cylinder” designates a cylinder comprising the following elements: a water feed close to one of the ends of the cylinder (connected to the overflow of the hydrocyclone), a clarified water outlet positioned at the other end of the cylinder, a discharge for solid particles positioned at the periphery of the cylinder between the feed and the outlet of the cylinder and connected to the hydroejector, and a centrifugation system.

The recirculation cylinder produces a vortex enabling centrifugation of the water coming from the overflow of the hydrocyclone, and enabling separation of the residual particles form the water. Thus, the particles are grouped on the walls of the recirculation cylinder and are sucked by the hydroejector 3.

The function of this recirculation cylinder is similar to that of a hydrocyclone in that the recirculation cylinder produces a vortex creating a centrifugation of the water contained in the cylinder, enabling a liquid-solid separation. The centrifugal force created by the turbulent flow in which the fluid rotates around an axis causes the ejection of solid particles at the periphery of the cylinder wall. The water discharged by a tangential outlet becomes loaded with solid particles. The clarified water is discharged at the centre of the cylinder. The recirculation cylinder 5 used in the device has a very fine cut-off threshold (of order 5 to 15 μm) adapted to the fineness of the residual suspended matter. This threshold depends on the flow rate, the pressure and the hydraulic residence time. Moreover, since the recirculation cylinder is positioned downstream of the hydrocyclone, it has a lower threshold than the latter. More specifically, since the hydrocyclone has carried out a first liquid-solid separation, only the finest particles remain present in the water transmitted to the recirculation cylinder. Consequently, in order to carry out an effective second solid-liquid separation, the cut-off threshold must be reduced.

Furthermore, in order to respond to the footprint constraint while optimising the treatment of the suspended matter, in an embodiment, the inventor fixed the length of the recirculation cylinder to 1.20 m. The hydraulic residence time inside this recirculation cylinder is between 1 and 4 seconds, with an optimum performance for 4 seconds, like the hydrocyclone. According to this embodiment, the recirculation cylinder had a similar size to the hydrocyclone; however, a different configuration in which their size differs is also possible. The recirculation cylinder was positioned horizontally.

The recirculation cylinder can be provided with a vent or a bleed enabling evacuation of the air which was introduced during the solid-liquid separation steps. More specifically, this air bleed, performed by a bleeder for example, prevents the accumulation of air at a high point which could cause a malfunction.

In the embodiment implemented by the inventor during its tests, the recirculation cylinder, functioned at a pressure of 1 to 1.5 bar.

### 2.7. Other Elements

In a variant of the invention, a complementary step 7 of adding polymer can be implemented downstream of the acceleration pump, or at the inlet of the recirculation cylinder. In order to further improve the performance of the device, automatic addition could be implemented as a function of the concentration of suspended matter at the inlet of the device.

A step of adding a coagulant 7 can also be implemented upstream of the polymer addition step.

A membrane valve can be positioned downstream of the acceleration pump, which could optionally enable the pressure to be adjusted.

3. Description of a Filtration Facility Equipped with a Device According to the Invention

According to an embodiment of the invention, the device DISP can be implemented at the backwash overflow outlet of a filter, this overflow being able to be either pressurised or gravity-driven. Within the facility upstream of the device, the water is coagulated and optionally flocculated beforehand. It may also contain solid mineral particles such as sand or clay.

Thus, the dirty water may be a backwash water from an ultrafiltration membrane, this ultrafiltration membrane enabling, for example, the filtration of an untreated water or of a pretreated water. According to an exemplary embodiment, untreated water (e.g. lake water) is coagulated, before being sent to an ultrafiltration membrane. The suspended matter is then coagulated and forms a cake by sticking on the ultrafiltration membrane. This cake is then unstuck by back washing and is discharged with the backwash water via the overflow of the dirty water tank, to the device of the invention. Then, the device according to the invention separates the water from the solid matter contained in the dirty overflow water, in order to limit the water losses of the facility.

According to another exemplary embodiment, the dirty water can be backwash water from a sand filter or granulated activated carbon, or even backwash water from a biofilter (for example Biostyr™).

4. Description of a Ballasted Flocculation-Settling Facility Equipped with a Device According to the Invention

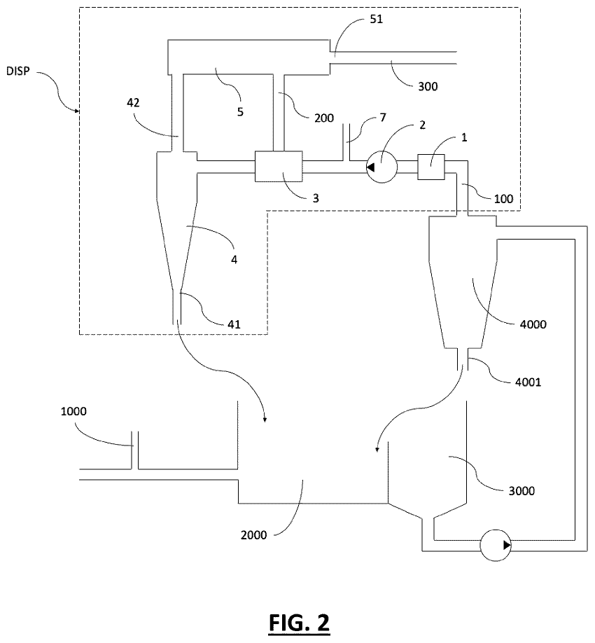

With reference to FIG. 2, an embodiment of the invention comprises the implementation of the device DISP inside a ballasted flocculation-settling facility. Such a ballasted flocculation-settling facility implements:
an optional coagulation step of the suspended matter contained in the water to be treated, by the addition of coagulants 1000 to the water to be treated, forming agglomerates of particles;
a step of flocculation of the suspended matter contained in the water to be treated, in a flocculation zone 2000, thus forming flocs;
an addition of granular material acting as ballast for the flocs, in the flocculation zone 2000;
settling of the suspended matter, flocs and granular material, in a settling tank 3000, thus forming a sludge;
feeding of sludge to a first hydrocyclone 4000, the first hydrocyclone separating part of the solid particles (suspended matter, flocs and granular material) from the sludge; recovering a sludge composed of the heaviest particles (mostly granular material) at the underflow 4001 of the first hydrocyclone, the granular material being recycled in order to be reused;
recovering a sludge composed of the lightest particles at the overflow (100) of the first hydrocyclone, this sludge (or dirty overflow water) still containing suspended matter, flocs and potentially granular material.

The facility also comprises a device DISP according to the invention as described above in connection with FIG. 1 (for simplicity, some elements of the device as described in FIG. 1 have been omitted in FIG. 2), and implementing the following steps:
degassing 1 the dirty overflow water 100 of the first hydrocyclone 4000;
feeding of degassed dirty water to a hydroejector 3 by an accelerating pump 2;
hydrocycloning the water at the hydroejector outlet 3, inside a second hydrocyclone
recovering granular material, flocs and suspended matter, at the underflow 41 of the second hydrocyclone;
centrifugation the overflow water 42 from the second hydrocyclone 4, inside a recirculation cylinder 5;
recirculation 200 of solid particles (granular material, flocs, suspended matter) by suction via the Venturi effect produced by the hydroejector 3, the water containing these solid particles being sucked by the hydroejector 3 into the recirculation cylinder 5, in order to be mixed, inside the hydroejector 3, with the degassed dirty overflow water feeding the hydroejector. The mixture then continues its circulation inside the device DISP in order to feed the second hydrocyclone 4, etc.
recovering a clarified water 300 at the outlet 51 of the recirculation cylinder, this water being able to be recycled to the head of the ballasted flocculation-settling facility;
continuously measuring and adjusting the flow rate in order to meet the following conditions: for a flow rate at the accelerating pump outlet of x m³/h, then the flow rate at the hydroejector outlet is between 1.1× and 1.5× m³/h, the flow rate at the underflow outlet of the second hydrocyclone is less than 0.1× m³/h, the recirculation flow rate is between 0.1× and 0.5× m³/h, and the flow rate at the overflow outlet of the recirculation cylinder is between 0.9× and 0.95× m³/h.

The underflow 41 of the second hydrocyclone can optionally be recycled if it contains, for example, residual activated carbon (use for the treatment of organic matter in the ballasted flocculation-settling facility) or carbonate ions if the ballasted flocculation-settling facility is used to remove water hardness.

### 5. Experimental Results

Tests were carried out with a dirty overflow water coming from a hydrocyclone forming part of a ballasted flocculation-settling facility, this dirty overflow water having 0.91 g/L of suspended matter. The results of these tests are presented below. According to these results, the clarified water at the recirculation cylinder outlet represents 90-95% of the water at the inlet of the device DISP. The tests also enabled it to be determined that at a lower temperature, the yield was better due to the increase in the viscosity of the water.

For an inner diameter of 8 mm at the Venturi effect nozzle outlet:

| Measured/calculated | | | | | | | | Average |
|---|---|---|---|---|---|---|---|---|
| quantity | Treatment step | Test 1 | | Test 2 | | Test 3 | | (%) |
| Flow rate | Device inlet (100) | 4.42 | | 5.01 | | 5.07 | | 100 |
| (m³/h) | Hydrocyclone feed | 6.25 | | 6.99 | | 7.08 | | 140 |
| | Hydrocyclone underflow | 0.357 | | 0.255 | | 0.245 | | 6 |
| | Recirculation line (200) | 1.83 | | 1.98 | | 2.01 | | 40 |
| | Device outlet (300) | 4.07 | | 4.6 | | 4.8 | | 93 |
| Suspended matter | Device inlet (100) | 0.91 (100%) | | | | | | 100 |
| content (g/L) | Hydrocyclone underflow | 9.33 | (83%) | 15.17 | (85%) | 17.26 | (92%) | 86 |
| | Device outlet (300) | 0.17 | (17%) | 0.15 | (15%) | 0.08 | (8%) | 14 |

For an inner diameter of 10 mm at the Venturi effect nozzle outlet:

| Measured/calculated | | | | | | | | Average |
|---|---|---|---|---|---|---|---|---|
| quantity | Treatment step | Test 1 | | Test 2 | | Test 3 | | (%) |
| Flow rate | Device inlet (100) | 6.71 | | 7.375 | | 7.415 | | 100 |
| (m³/h) | Hydrocyclone feed | 7.5 | | 8.45 | | 8.375 | | 113 |
| | Hydrocyclone underflow | 0.235 | | 0.148 | | 0.142 | | 2 |
| | Recirculation line (200) | 1.83 | | 1.98 | | 2.01 | | 13 |
| | Device outlet (300) | 4.07 | | 4.6 | | 4.8 | | 97 |
| Suspended matter | Device inlet (100) | 0.91 (100%) | | | | | | 100 |
| content (g/L) | Hydrocyclone underflow | 23.01 | (89%) | 42.9 | (95%) | 45.6 | (96%) | 93 |
| | Device outlet (300) | 0.11 | (11%) | 0.05 | (5%) | 0.05 | (5%) | 7 |

1-16. (canceled)

17. A method for treating a dirty water coming from a water treatment plant in order to separate, on the one hand, treated water and, on the other hand, solid particles contained in the dirty water, said solid particles comprising suspended matter and/or insoluble granular material that is heavier than water, wherein said method comprises the following steps:
a step of degassing said dirty water;
a step of feeding degassed dirty water to a hydrocyclone via a hydroejector fed by an accelerating pump, said accelerating pump being capable of adjusting a flow rate and a pressure;
a first separation step, of suspended matter and/or granular material present in said degassed dirty water, by hydrocycloning inside said hydrocyclone;
a step of recovering an overflow of said hydrocyclone, said overflow from the hydrocyclone mainly comprising residual suspended matter;
a second separation step, by centrifugation, of the residual suspended matter from the recovered overflow water from said hydrocyclone, inside a recirculation cylinder, configured to separate, by centrifugation, residual suspended matter from the water recovered at the overflow of said hydrocyclone and comprising, a feed of overflow water from said hydrocyclone at a first end of said cylinder, an overflow outlet of clarified water positioned at a second end of said cylinder, a solid particles discharge positioned on the periphery of said cylinder between the feed and the outlet of said cylinder and connected to the hydroejector, and a centrifugation system;
a step of recirculating, to said hydrocyclone, water comprising said residual suspended matter coming from said recirculation cylinder through suction by said hydroejector;
a step of extracting clarified water at the overflow outlet of said recirculation cylinder;
a step of continuously measuring the flow rate at the outlet of said accelerating pump, the flow rate at the outlet of said hydroejector, and the flow rate at the outlet of said recirculation cylinder.

18. The method according to claim 17, comprising:
a step of continuously adjusting said flow rate of said accelerating pump as a function of the result of the measurement taken during said measurement step;
said step of adjusting the flow rate of said accelerating pump being such that, for a flow rate at the outlet of said accelerating pump of x m³/h, then the flow rate at the hydroejector outlet is between 1.1× and 1.5× m³/h, the flow rate at the underflow outlet of the hydrocyclone is less than 0.1× m³/h, the recirculation flow rate is between 0.1× and 0.5× m³/h, and the flow rate at the overflow outlet of the recirculation cylinder is between 0.9× and 0.95× m³/h.

19. The method according to claim 17, comprising a step of adding polymer to the water downstream of said accelerating pump and/or at the inlet of said recirculation cylinder.

20. The method according to claim 18, wherein said flow rate at the outlet of said accelerating pump x is between 4 and 50 m³/h.

21. The method according to claim 17, wherein the hydraulic residence time is between 2 s and 4 s inside said hydrocyclone and said recirculation cylinder.

22. The method according to claim 17, wherein said hydrocyclone has a cut-off threshold between 10 and 25 μm, and said recirculation cylinder has a cut-off threshold between 5 and 15 μm.

23. The method according to claim 17, comprising adapting the pressure of the water at the outlet of said accelerating pump, said outlet pressure of said accelerating pump being between 2 and 5 bar.

24. The method according to claim 17, wherein said hydroejector comprises a nozzle for which the outlet diameter is between one fifth and one half of its inlet diameter.

25. The method according to claim 17, wherein said dirty water comes from a hydrocyclone of a ballasted flocculation-settling facility.

26. The method according to claim 17, wherein the dirty water comes from a filtration system, said filtration system belonging to the group comprising:
sand filters;
granulated activated carbon filters;
ultrafiltration membranes;
biological filters using a biomass fixed on a granular support;
mechanical filters.

27. A device (DISP) for treating dirty water coming from a water treatment plant in order to separate suspended matter and/or insoluble granular material that is heavier than water, in order to implement a method according to claim 1, wherein it comprises:
degassing means at the inlet of said device;
an accelerating pump capable of adjusting a flow rate and a pressure of the water coming from the degassing means;
a hydroejector fed by said accelerating pump;
a hydrocyclone fed by the water coming from the hydroejector;
a recirculation cylinder configured to separate, by centrifugation, residual solid matter from the water recovered at the overflow of said hydrocyclone, one wall of said recirculation cylinder being connected to said hydroejector;
means for measuring pressure and/or flow rate, disposed at the outlet of said accelerating pump, at the outlet of said hydroejector and at the overflow outlet of said recirculation cylinder;
said hydroejector being capable of recirculating a part of the water coming from the recirculation cylinder to the hydrocyclone.

28. The device according to claim 27, comprising polymer adding means provided downstream of said accelerating pump, and/or at the inlet of said recirculation cylinder.

29. The device according to claim 27, wherein said hydrocyclone has a cut-off threshold between 10 and 25 μm, and said recirculation cylinder has a cut-off threshold between 5 and 15 μm.

30. The device according to claim 27, wherein said hydroejector comprises a nozzle for which the outlet diameter is between one fifth and one half of its inlet diameter.

31. The device according to claim 27, wherein the recirculation cylinder is positioned horizontally.

32. The device according to claim 27, wherein said hydrocyclone and said recirculation cylinder each have a length between 0.8 and 2 m.

33. A method of treating water containing suspended matter and granular material heavier than the water, the method comprising:
removing air from the water by degassing the water;
directing the water to a pump and pumping the water to and through a Venturi and from the Venturi into a hydrocyclone;
in the hydrocyclone, separating the water into an underflow and an overflow where the underflow includes the granular material and the overflow includes the suspended matter;
discharging the underflow including the granular material from the hydrocyclone;
directing the overflow containing the suspended matter from the hydrocyclone into and through a recirculation cylinder;
separating the suspended matter from the overflow in the recirculation cylinder through a centrifugation process and wherein the separation is facilitated by the formation of a vortex and through centrifugal force which results in the suspended matter collecting on the periphery of the recirculation cylinder;
discharging clarified water from the recirculation cylinder;
wherein the recirculation cylinder is operatively connected to the Venturi;
wherein the Venturi induces the suspended matter collected on the periphery of the recirculation cylinder to move from the recirculation cylinder to the Venturi where the suspended matter from the recirculation cylinder is mixed with the water being discharged from the Venturi.

34. The method of claim 33 including measuring the flow rate at outlets associated with the hydrocyclone, the Venturi, the recirculating cylinder, and the pump, and adjusting the flow rate of the outlet of the pump based on the flow rates of the hydrocyclone, the Venturi, and the recirculating cylinder.
